(19) United States
(12) Patent Application Publication
(10) Pub. No.: US 2010/0229218 A1
(43) Pub. Date: Sep. 9, 2010

(54) QUOTA MANAGEMENT FOR NETWORK SERVICES

(75) Inventors: Vishwajith Kumbalimutt, Redmond, WA (US); Ryan Mack, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/398,195

(22) Filed: Mar. 5, 2009

(51) Int. Cl. H04L 9/32; G06F 15/173; G06F 17/30; G06F 21/00

(52) U.S. Cl. 726/4; 709/226; 707/E17.005

(57) ABSTRACT

A system and method for managing requests for system resources from a plurality of users. Usage data is maintained for each user with respect to a user quota and a system quota. Aggregate system usage data is also maintained. A user request is checked for compliance with a user quota. The request is checked for compliance with a system quota. If either quota is not complied with, a hint that indicates when to send a next request is determined and sent to the user. Compliance with the system quota may include use of a reservation system, in which the allowance of a request may be based on a user's system usage data, so that a user with lower usage is more likely to have a request accepted when the system is loaded.

### TECHNICAL FIELD

The present invention relates generally to computer systems, and, more particularly, to managing requests from clients.

### BACKGROUND

A data center may be made up of one or more servers and computing devices configured to receive requests from users and provide services. Users may be grouped, for example, by school, company, or other entity. Services may include actions such as returning a web page or file, setting up an account, or access to various data. Providing services such as these generally require various system resources, such as CPU cycles, memory, bandwidth, and the like. In a situation where the aggregate rate of resource usage due to providing services in response to requests received from the users is high relative to the system's limits, user requests may be denied, delayed, or otherwise result in undesirable consequences. In some configurations, it may be possible for a single user to use a high amount of system resources, denying or limiting other users access to the resources.

It is desirable to configure a system to work at a high efficiency. It is also desirable to allocate limited resources in a fair way. It is further desirable to enable an administrator to configure the system to modify parameters or policies with respect to managing resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to manage requests for services from multiple users. The mechanisms include maintaining one or more user quotas for each user and maintaining one or more system quotas shared by the users. Each user's request is processed to determine whether it is in compliance with the quotas. If it is, the request is enabled and the services provided. If the request is not in compliance, the request is rejected.

In one aspect of the system, the computer system may receive a request for a service from a user, determine whether the request is compliant with a user quota corresponding to the user, determine whether the request is compliant with a system quota, and selectively enable the requested service based on whether the request is compliant with the user quota and the system quota. The determination of whether the request complies with the user quota may be based on a user quota usage value, such as a rate of use by the user. The determination of whether the request complies with the system quota may be based on a system quota usage value corresponding to the user. System quota compliance may also be based on an aggregate system quota usage value.

In one aspect of the system, a hint may be determined and sent to a requesting user. The hint may indicate a time period for the user to wait prior to sending a subsequent message. This may be based on a prediction of a time that will allow the subsequent message to be compliant with one or more user quotas, one or more system quotas, or a combination thereof. In one aspect of the system, a user quota hint and a system quota hint may be determined, and the more restrictive hint sent to the user. The sending of the hint may be done when a request is rejected, or it may be sent for both rejections and allowances of the request. The hint may be based on a time interval since a previous request by the requesting user. It may be based on the system quota and a system quota usage value corresponding to another user other than the requesting user. The hint may be based on ranking each user by the rate of requests received from each user.

In one aspect of the system, usage values are modified by decaying each value by an amount based on the corresponding quota. A system quota usage value may be decayed by an amount based on the number of users, or more specifically, the system quota divided by the number of users.

In one aspect of the system, determining whether the request is compliant with the system quota may be based on a system quota usage value of the user relative to other system quota usage values corresponding to other users. The determination may be based on the order of the users with respect to their corresponding system quota usage values, wherein the usage values are based on prior requests received from each of the users. A user with a lower system quota usage value may have a higher likelihood of success in a system that is heavily loaded.

In one aspect of the system, while the system is running and the processes are being performed, one or more user quotas or system quotas may be modified. The processes may continue to be performed using existing usage values, without having to reset the usage values.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram of an environment in which the mechanisms herein described may be employed;

FIG. 2 is a block diagram of a computer system that may employ the mechanisms herein described;

FIG. 3 is a flow diagram illustrating a high level view of a process for managing user requests, in accordance with an embodiment of the mechanisms described herein;

FIG. 4 is a flow diagram illustrating a process of receiving and processing a user request, in accordance with an embodiment of the mechanisms described herein.

FIG. 5 is a flow diagram generally showing a process of evaluating a request for compliance with one or more concurrency limits and quotas, in accordance with an embodiment of mechanisms described herein;

FIG. 6 illustrates the use of a token bucket to manage user requests, in accordance with an embodiment of mechanisms described herein;

FIG. 7 is a flow diagram generally showing a process of evaluating compliance with a user rate quota, in accordance with an embodiment of mechanisms described herein;

FIG. 8 is a conceptual view of a system for evaluating compliance with a system quota, in accordance with an embodiment of the mechanisms described herein; and

FIG. 9 is a flow diagram generally showing a process of evaluating compliance with a system rate quota, in accordance with an embodiment of the mechanisms described herein.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The components described herein may execute from various computer readable media having various data structures thereon. The components may communicate via local or remote processes such as in accordance with a signal having one or more data packets (e.g. data from one component interacting with another component in a local system, distributed system, or across a network such as the Internet with other systems via the signal). Computer components may be stored, for example, on computer readable media including, but not limited to, an application specific integrated circuit (ASIC), compact disk (CD), digital versatile disk (DVD), read only memory (ROM), floppy disk, hard disk, electrically erasable programmable read only memory (EEPROM), flash memory, or a memory stick in accordance with embodiments of the present invention.

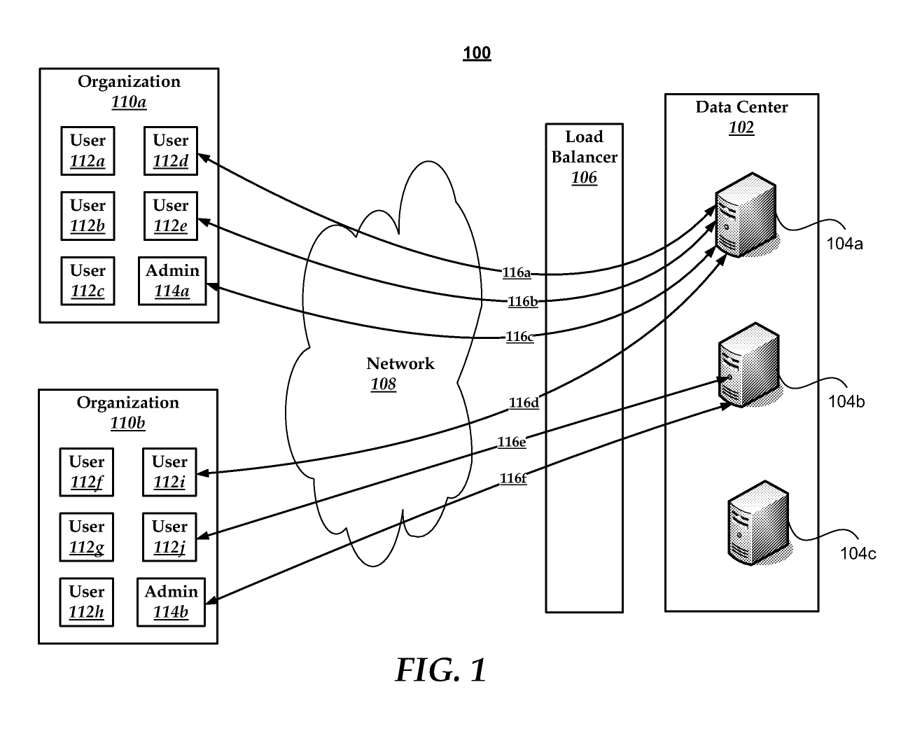

FIG. 1 is a block diagram of a computer network environment 100 in which mechanisms described herein may be implemented. FIG. 1 is only an example of a suitable environment and is not intended to suggest any limitation as to the scope of use or functionality of the present invention. Thus, a variety of system configurations may be employed without departing from the scope or spirit of the present invention.

As illustrated, environment 100 includes a data center 102, which itself includes servers 104a-c. Servers 104a-c may be colocated or may be geographically distributed. Data center 102 may include a single server 104 or many servers 104, though three servers 104a-c are shown for illustrative purposes. Each server 104a-c is a computing device having one or more processing units and associated components.

Data center 102 may include additional computing devices, such as data storage devices, switches, routers, or the like. Servers 104a-c may be in direct or indirect communication with each other, though it is not required by the mechanisms described herein. Though not illustrated in FIG. 1, in one embodiment, each of servers 104a-c may communicate with a storage device that maintains data used for implementing the mechanisms described herein.

In the illustrated environment, load balancer 106 is topologically positioned between servers 104a-c and remote computing devices. Generally, load balancer 106 manages traffic between remote computing devices and servers 104a-c. Load balancer 106 may receive various messages or requests from remote computing devices and employ logic to determine a corresponding server from among the servers 104a-c of the data center. In one embodiment, load balancer 106 employs logic that implements “stickiness” or “persistence” between a remote computing device and a server. Performance of this logic is such that, after a first request or communication between a remote user and a server, subsequent communications from the remote user are directed toward the same server. This feature enables a variety of functionality. For example, a server may maintain data from a first communication with a remote user and use the data to process a second communication with the same user. Load balancer 106 may perform other traffic management functions, such as terminating SSL connections, providing security, or monitoring the health of servers 104a-c.

Servers 104a-c may communicate with remote devices by way of a network 108. Network 108 may include a local area network, a wide area network, or a combination thereof. In one embodiment, network 108 includes the Internet, which is a network of networks. Network 108 may include wired communication mechanisms, wireless communication mechanisms, or a combination thereof. Communications between servers 104a-c and any other computing devices may employ one or more of various wired or wireless communication protocols, such as IP, TCP/IP, UDP, HTTP, SSL, TLS, FTP, SMTP, WAP, Bluetooth, or the like.

As illustrated in FIG. 1, environment 100 includes organizations 110a-b, though it may include more or less organizations. An organization may be an entity such as a school, a company, an organized group of users or computing devices, or other such entity. An organization may include one or more users, such as users 112a-112j. As illustrated, organization 110a includes users 112a-e, and organization 110b includes users 112f-j. Organization 110a also includes administrator 114a, while organization 110b includes administrator 114b. An administrator is a special type of user, and discussion of users herein includes administrators, unless stated otherwise. An administrator for an organization may perform tasks to manage devices of the organization, and is generally not an administrator of data center 102. An organization's administrator may have, but does not necessarily have, full rights to administer servers 104 or other devices of data center 102. An organization may include many users or as few as one user. Some organizations may include thousands or tens of thousands of users, or more, or less users.

A user may be a person, a computing device, or an executing process. A user is distinguished by identifying information or credentials that distinguish it from other users. One or more software processes may execute on a single computing device, each process considered to be a distinct user.

Though FIG. 1 illustrates two classes of users administrators and non-administrators some environments may include a single class of users or many classes of users. The mechanisms described herein may be employed with any number of user classes.

Arrows 116 represent communications between users and corresponding servers. More specifically, as illustrated, user 112d, user 112e, user 112i, and administrator 114a communicate with server 104a; user 112j and administrator 114b communicate with server 104b. Each of these communications occurs via network 108 and through load balancer 106. Each of these communications may include one or more communication protocols, and one or more requests. A request may be for a service, such as storage, retrieval, or processing of data. Services may include providing a web page, a file, or other type of data. Services may include setting up or managing an account, establishing a connection, executing a program, or any of a number of services that servers 104 may provide.

Each request may employ one or more of a number of computing resources from a finite supply of resources. For example, a request may employ an amount of CPU time, an amount of memory, an amount of communications bandwidth, one or more system processes or threads, an amount of disk or storage accesses, or other resources provided by a server. Computing units may be used to represent underlying resource usage. For example, in one embodiment, each request may itself be considered a computing resource, such that a number of requests that are processed in a specified time period may be used as a unit to monitor resource usage. A resource subject to a quota may be classified as such in a variety of ways. For example, in one embodiment, requests that are directed to releasing resources may be excluded from the set of requests that are subject to a quota. Mechanisms for managing requests for such resources from multiple users are described herein.

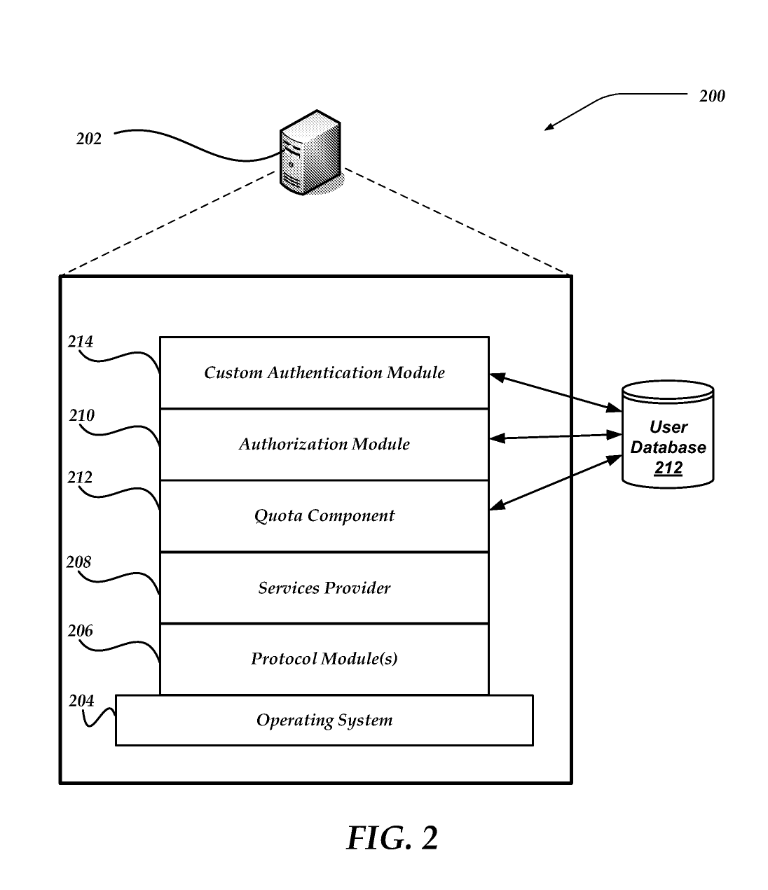

FIG. 2 illustrates a computing system 200 that may be employed with the mechanisms described herein. Computing system 200 includes a server 202, which may be one or more of servers 104a-c of FIG. 1. Server 202 may be a web server, application server, or other server that provides services to remote users. Server 202 may refer to software that executes on one or more computing devices, electronic components that include program logic, a computing device, or a combination thereof. A computing device may be a special purpose or general purpose computing device. In brief, one embodiment of a computing device that may be employed includes one or more processing units, a mass memory, and a communications interface. Example computing devices include mainframes, servers, blade servers, personal computers, portable computers, communication devices, consumer electronics, or the like.

As illustrated, server 202 communicates with user database 216. User database 216 may be integrated with server 202 or reside on the same computing device, or it may reside on a separate computing device. User database 216 may be shared by multiple servers 202. User database 216 may include data storage media, user data, and program logic for accessing the user data. User database 216 may include a record for each user. The data stored in a user record, or referenced by a user record, may include the user quota specification, current system usage, one or more timestamps of the most recent request or resource usage, a token bucket or other data structure for managing one or more user quotas, user quota usage data, system quota usage data, as well as other data. User records may be organized in any of a variety of structures. In one embodiment, user records are kept in a skip list. Briefly, a skip list is a data structure that includes multiple parallel, sorted linked lists, allowing for efficient lookup of individual records.

As illustrated, server 202 includes several program modules. Briefly, operating system 204 may be any general or special purpose operating system. The Windows® family of operating systems, by Microsoft Corporation, of Redmond, Wash., are examples of operating systems that may execute on server 202.

As illustrated, server 202 further includes services provider 208 and protocol module 206. Services provider 208 provides, in response to requests, one or more of a variety of services as discussed herein, such as Internet or application services. Protocol module 206 may include one or more submodules that handle specific communication protocols, such as HTTP, FTP, SMTP, as well as other protocols. For example, protocol module 206 may receive an HTTP request for a web page, process the protocols, and pass the request to services provider 208. Services provider 208 may process the request by retrieving or generating a web page and returning the response to protocol module 206 for sending to the requester. Services provider 208 may process FTP requests, data requests, perform compression or decompression, log requests, or perform a number of other services in response to client requests. Services provider 208 may delegate at least a portion of service processing to one or modules, including modules that are specialized to process designated types of requests. As discussed herein, reference to service processing by services provider 208 includes processing performed by auxiliary modules. Internet Information Services, by Microsoft Corporation, is one example of services provider 208.

Authorization module 210 may include logic to authorize that a user making a service request is authorized to make the request. Authorization module 210 may employ any of a variety of logic to determine whether a user is authorized to use the service being requested. In some configurations, each class of user may have a corresponding set of services that they are authorized to use.

Server 202 may also include authentication module 214. Authentication module 214 may be included within authorization module 210 or it may be implemented as a plug-in or auxiliary module to authorization module 210. In one embodiment, authentication module 214 may include logic to authenticate a particular group of users, such as users of an organization. It may be provided by an administrator of the organization or custom configured for the organization. One or more authentication modules 214 may be employed in server 202, each such module performing authentication processing for a group of users.

As illustrated, server 202 further includes quota compliance component 212. This component may include program logic to maintain and enforce quotas, including determining a usage by a user or entity, determining when a request exceeds a quota, and enabling a requested service based on whether it exceeds one or more applicable quotas. Quota compliance component 212 may provide users with hints to facilitate subsequent requests. This logic is described in further detail herein.

Though FIG. 2 illustrates a single server 202, in some configurations, computing system 200 may include multiple servers. Each server may communicate with user database 216, which may be a centralized or distributed database. Each server 202 may communicate directly or indirectly with other servers 202. Successive requests by a user may be received by different servers 202, with user records or user data available to each server, such that multiple servers may perform the processes described herein in a manner similar to a single server performing the processes.

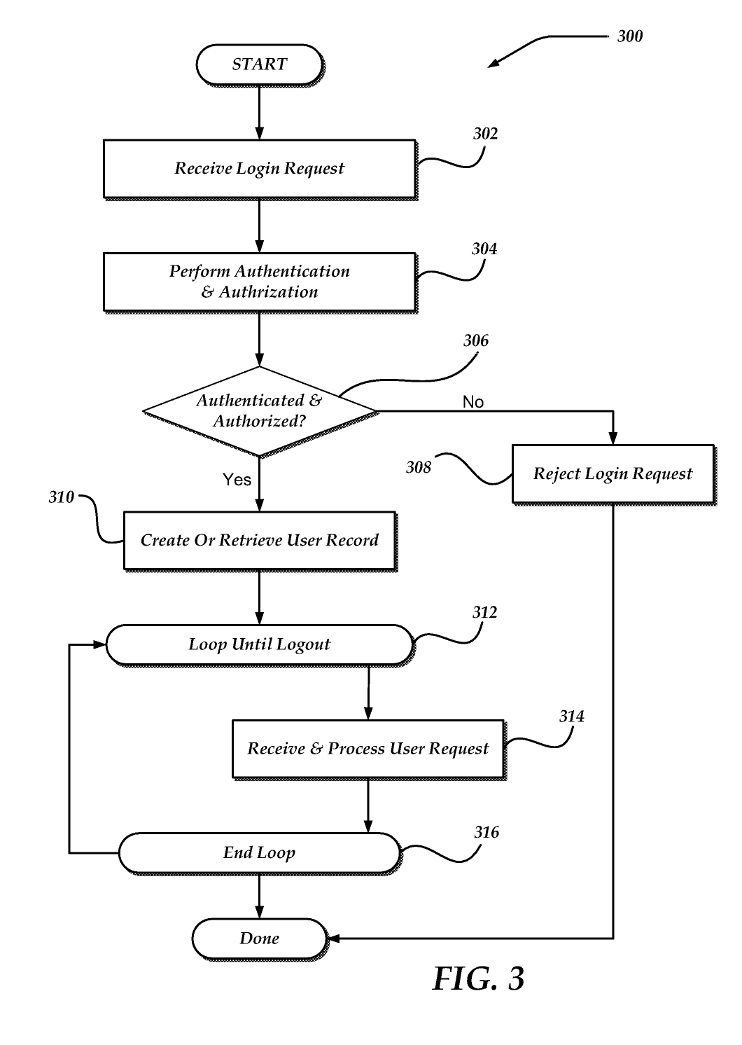

FIG. 3 is a flow diagram illustrating a high level view of a process 300 for managing user requests, in accordance with an embodiment of the invention. Process 300 may be employed by a server, such as server 202 of FIG. 2, or by another computing device. Process 300 may be employed in environment 100 of FIG. 1, or in another computing environment. As shown in FIG. 3, after a start block, at block 302, a user login request is received. The request may be received in accordance with any of a number of Internet or application protocols, such as HTTP, SMTP, or the like. As discussed herein, the login request may be processed by a protocol module or a services module. Typically, the request includes or is accompanied by credentials that identify the sender.

Process 300 may flow to block 304, where authentication and authorization of the login request sender is performed. In one embodiment, authentication may be performed by a first component, such as authentication module 214, and authorization may be performed by a second module, such as the authorization module 210 of FIG. 2. In one embodiment, authentication and authorization may be performed by the same component. In some embodiments, authentication of a user's credentials automatically authorizes the user. A user may be identified by a user ID, user credentials, or other identifying information. In one implementation, more than one request sender may use the same user data, for example, the same login ID and password, and they would be considered as a single user.

Process 300 may flow to block 306, where a determination of whether the login request sender is authenticated and authorized is made. If the sender is not authenticated or authorized, processing may flow to block 308, where the login request is rejected. Processing may then flow to a done block.

If, at decision block 306, the login request sender is both authenticated and authorized, the process may flow to block 310, where a user record for storing usage information of the user may be created or retrieved. In one implementation, the usage information may include a user quota usage value that indicates a rate of usage by the user corresponding to a user quota and a system quota usage value that indicates a rate of usage by the user corresponding to a system quota. The usage information may include one or more timestamps that indicates a time of one or more of the most recent user requests. In some implementations, the user record may be maintained beyond a logout action, so that during a subsequent login, the user record may be retrieved, and it is not necessary to create a new user record. In one implementation, a user record may be deleted or deactivated after a time period in which the user has not logged in or has not made new requests. In one implementation, a garbage collection process may be used to delete expired user records. The expiration time period may be determined based on the quotas. It may also be based on the user's recent usage rate, such that the user has been inactive long enough for its usage rate to be considered zero.

Processing may flow to block 312, where a request loop begins, herein referred to as loop 312. Loop 312 includes the actions of block 314, receiving and processing a user request. In various embodiments, a request may be an Internet request, such as an HTTP or FTP request, an application request, or a system request.

Processing may flow to block 316, where loop 312 is terminated. Loop 312 may terminate when the user is logged out. This may occur as the result of a user request to log out, a time out, a server-initiated time out, or in response to another action. Processing may flow to a done block.

Though FIG. 3 illustrates a process 300 in which one or more requests occur in a loop, two or more requests from a user may occur concurrently within process 300. Multiple requests may be received prior to processing one of them, or a request may be received while a prior request is being processed. Thus, multiple instances of block 314 may be performed concurrently, and each instance may be in the same or different stage of processing as the others. In some implementations, a command to log out may interrupt processing of a request in block 314. In some implementations, the process may wait until ongoing requests are processed prior to logging out.

A server may execute multiple instances of process 300 concurrently, each instance corresponding to a user. Each instance may be at the same or different stage of processing as the other instances.

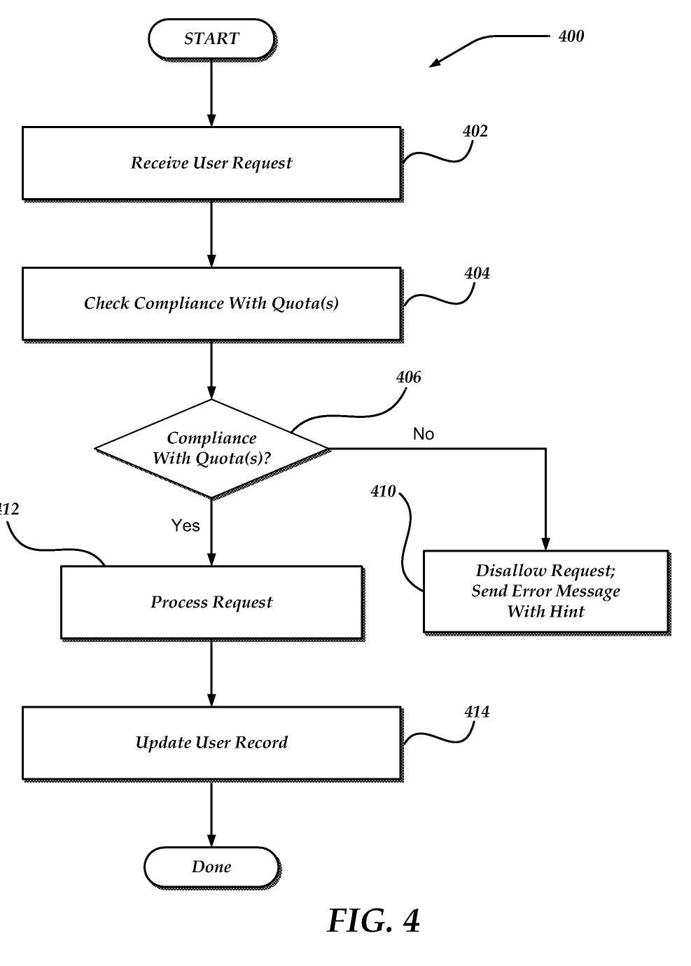

FIG. 4 illustrates a process 400 of receiving and processing a user request, in accordance with an embodiment of the invention. Process 400 may be a more detailed view of the actions of block 314 of FIG. 3, and may be understood in that context. As illustrated, after a start block, at block 402, a user request is received. For discussion purposes, as used herein, the term “current request” refers to the request that has been received and is being processed as illustrated by FIG. 4 and other FIGURES. The term “current user” refers to the user corresponding to the current request. Typically, the current user is the user that has sent the current request, though in some configurations, a first user may act as a delegate of a second user, and send a request on behalf of the second user. In one implementation, the second user may be considered to be the current user in this configuration. For discussion purposes, the user sending the request is considered to be the current user.

Processing may flow to block 404, where the request is evaluated with respect to one or more specified quotas and concurrency limits. As discussed herein, the specified quotas may include a user quota corresponding to the requesting user and a system quota. A quota may specify an amount of resource per time period. A more detailed discussion of quotas and evaluation is provided herein. The actions of block 404 may also include evaluating the request with respect to one or more concurrency limits as discussed herein.

Process 400 may flow to decision block 406 where a determination is made of whether there has been compliance with the one or more quotas. Optionally, the determination may include one or more concurrency limits. In one implementation, the request must comply with all relevant quotas and concurrency limits in order to be accepted, though the system may be configured to specify the set of quotas and concurrency limits. If the request has not complied with a quota or concurrency limit, processing may flow to block 410, where the request is disallowed. Disallowing one or more requests from a user is referred to as “throttling” the user request(s). At block 410, an error message may be sent to the request sender. In one embodiment, the error message may include a user hint. A user hint may provide a user with information suggestive of how to send a subsequent request to have the request allowed, or at least increase a likelihood of the request being allowed. In one embodiment, a hint may include an indication of a time period to wait prior to sending a subsequent message. Determination of user hints is discussed in more detail herein. In one implementation, rejection of a request may include delaying the request until a time when it may be allowable, and then processing the request. Processing may flow to a done block.

If, at decision block 406, it is determined that the one or more quotas have been complied with, the request may be allowed. Processing may flow to block 412, where the request is processed. As discussed herein, processing the request may include performing one or more of a number of Internet, application, or system services. This may include processing HTTP, FTP, SMTP, or other types of protocol requests. In one implementation, at least a portion of the actions of block 412 may be performed by services provider 208 of FIG. 2.

Processing may flow to block 414, where a user record corresponding to the request sender may be updated to indicate that the request has been processed. Updating the record may include recording a timestamp of the request, incrementing a request or resource count, updating a usage rate, or modifying other data indicative of a processed request or of the amount of resources used. Processing may flow to a done block and return to a calling program.

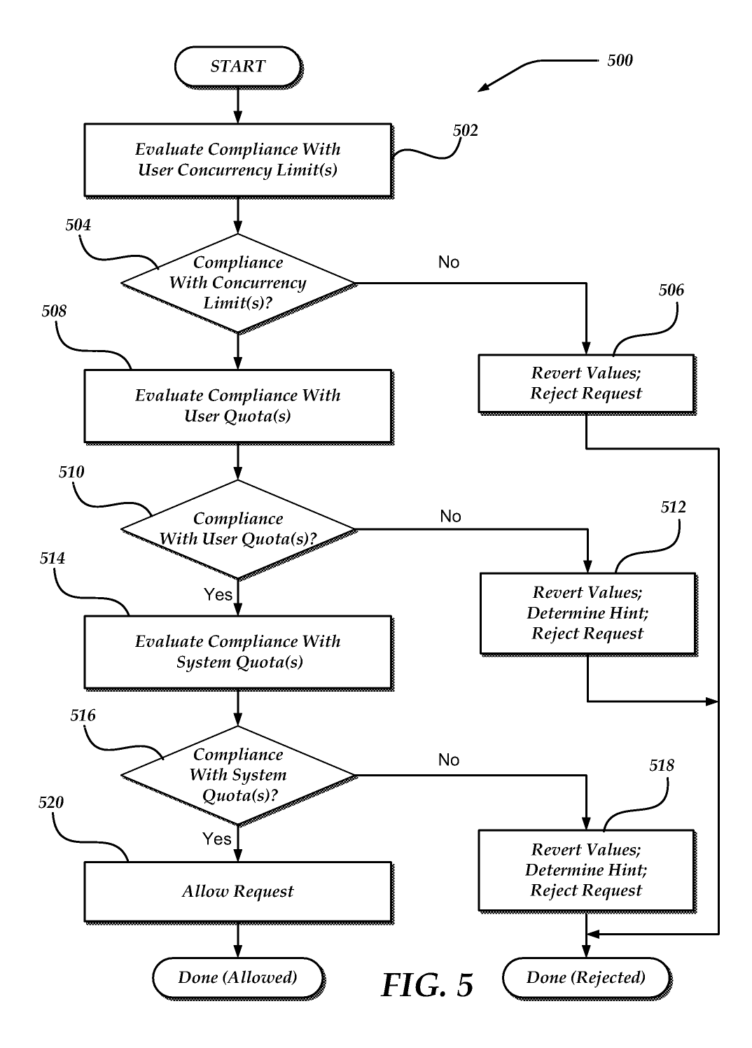

FIG. 5 illustrates a process 500 of evaluating a request for compliance with one or more concurrency limits and quotas, in accordance with an embodiment of the invention. Process 500 may be a more detailed view of the actions of block 404 of FIG. 4, and may be understood in that context. In one implementation, the actions of process 500, or at least a portion thereof, may be performed by quota component 212 of FIG. 2.

As illustrated, after a start block, at block 502, compliance with one or more user concurrency limits may be evaluated. A concurrency limit may specify an amount of a system resource that may be used or reserved concurrently by the user. As used herein, a resource that is reserved by a user, such as a block of memory, is considered to be in use by the user. These system resources may include a number of system shells, processes, threads, memory blocks, or other finite resource. In one implementation, prior to, or in conjunction with, evaluating a concurrency limit, a user resource value may be incremented. A user resource value may indicate the amount of the resource that is in use by the user. Performing the value update prior to, or in conjunction with, the evaluation may assist in maintaining integrity when handling multiple concurrent requests.

A user concurrency limit is applicable to the user corresponding to the request being evaluated (the current user). In some configurations, this may be a limit that applies to each user of a group or class, such as administrative users or non-administrative users. In some configurations, various users may have differing user concurrency limits. Though not illustrated in FIG. 5, process 500 or an associated process may include retrieving the applicable user limit. The process may also include retrieving user rate quotas or system rate quotas, discussed below.

Process 500 may flow to block 504, where a determination is made of whether the request complies with one or more concurrency limits, as evaluated in block 502. If the limit is not complied with, processing may flow to block 506, where the user concurrency values may be reverted back to a state prior to the evaluation and the request may be rejected. Processing may flow to a done block and return to a calling program. For example, in one implementation, the process may return to decision block 406 of FIG. 4, where limit and quota non-compliance is handled.

If, at block 504, it is determined that concurrency limits are complied with, processing may proceed to block 508, where compliance with one or more user quotas may be evaluated. As used herein, the term quota refers to a rate of usage, such as an amount of a resource per specified time period. The system resource may be a resource such as bandwidth, CPU, memory, processes, threads, or the like. In one implementation, service requests are used as the system resource, such that a quota is specified in terms of number of requests per unit of time. Other examples of quotas are number of memory allocations per unit of time, number of threads created per unit of time, or floating point calculations per unit of time. Multiple quotas may be specified that describe rates of the same or similar resource with respect to different units of time. For example, a first quota might be number of requests per second, while a second quota might be number of requests per minute, both quotas being used together. In another example, a first quota might be number of requests per second, while a second quota might be a number of memory units allocated per second.

A brief discussion of user quotas and system quotas is now provided. Briefly, a user quota is a rate of a resource usage for a user that is independent of other user quotas for other users. Typically, there exists a one-to-one or one-to-many relationship between users and user quotas, such that a first user does not use up any of the quota of a second user. In some configurations, multiple users may share a user quota; however, in the mechanisms described herein, the multiple users are considered a single user. A user quota is referred to herein as “user quota rate” or simply, a “user quota.” A measurement of a rate of resource usage used to determine compliance with a user quota is referred to herein as “user quota usage and the value is a user quota usage value or datum.

A system quota is a rate of a resource usage that limits the aggregate resource usage of a plurality of users, where the aggregate may be all users or any specified subset containing a plurality of users. Thus, resource usage by one or more users may limit the resource availability of other users. A system quota is referred to herein as “system quota rate” or simply, a “system quota.” A measurement of a rate of resource usage by a user used to determine compliance with a system quota is referred to herein as “system quota usage and the value is a system quota usage value or datum. A measurement of the aggregate rate of resource usage by multiple users used to determine compliance with a system quota is referred to herein as “aggregate system quota usage,” and the value is an aggregate system quota usage value or datum.

The system resource restricted by a user quota or a system quota may be any system resource. In a particular configuration, a system quota and a user quota may relate to the same or different system resources. Multiple user quotas or system quotas may relate to the same resource over different time intervals. In one implementation, a system quota may specify an aggregate number of requests per specified time interval.

The actions of block 508 may include a number of tasks, including retrieving the user quota specifications, maintaining a user quota usage rate of the current user, updating the user quota usage rate based on the current request, and performing calculations to determine whether the request complies with the quota, based on the usage rate. These tasks are discussed in further detail herein. Briefly stated, in one implementation, a result of these actions may be an affirmative or negative determination of compliance.

Processing may flow to decision block 510, where a process flow is decided based on the determination of compliance. If the request is found to be non-compliant, the process may flow to block 512. At block 512, the process may perform actions to revert the usage data to its state prior to performing the quota evaluation. Updating the usage data prior to, or in conjunction with, performing an evaluation assists in processing multiple requests from the same user concurrently. Therefore, this data may be restored upon a finding of non-compliance.

The actions of block 512 may include determining a hint. As discussed above, a user hint may provide a user with information suggestive of how to send a subsequent request to increase a likelihood of success. Determination of user hints is discussed in more detail herein. The actions of block 512 may include rejecting the user request. Rejection of a request may include sending an error message to the current user, or returning an error status to a calling program that disallows the requested service and sends the error message. Processing may flow to a done block, and return to a calling program.

If, at decision block 510, it is determined that the one or more user quotas have been complied with, processing may flow to block 514, where compliance with one or more system quotas may be evaluated.

The actions of block 514 may include a number of tasks, including retrieving the system quota specifications applicable to the current user, maintaining a system quota usage value of the current user as well as other users contending for the same resource, updating the user usage value and system quota usage value based on the current request, and performing calculations to determine whether the request complies with the system quota, based on the system quota usage value and the aggregate system quota usage value. In one implementation, an evaluation includes determining whether the current request is to be allowed based on the system quota and the current user's usage. These tasks are discussed in further detail herein. Briefly stated, in one implementation, a result of these actions may be an affirmative or negative determination of compliance.

Processing may flow to decision block 516, where a process flow is decided based on the determination of compliance. If the request is found to be non-compliant, the process may flow to block 518. At block 518, the process may perform actions to revert the current user and system usage data to its state prior to performing the quota evaluation. Updating the usage data prior to, or in conjunction with, performing an evaluation assists in processing multiple requests concurrently. Therefore, this data may be restored upon a finding of non-compliance.

As discussed with respect to block 512, the actions of block 518 may include determining a hint and rejecting the user request. Determination of user hints is discussed in more detail herein.

If, at decision block 516, the current request is found to be compliant, process 500 may flow to block 520, where the request is allowed. Allowing the request may include flowing to a done block and returning a success status to a calling program, where the requested service is enabled and may be performed.

In one embodiment, the actions of block 508, evaluating compliance with user rate quotas, may be implemented by use of token bucket techniques. A token bucket is a mechanism in which an abstract container holds a certain amount of tokens, each token representing a unit of a resource. In this context, the number of tokens represents the maximum rate, or quota, for a time period. For example, if the quota is 50 requests per 10 seconds, a token bucket may hold a maximum of 50 tokens, each token representing one request. Each time a request is received, a token is removed from the token bucket. If there are no tokens left, the request is rejected. Tokens are added to the bucket at a rate equal to the quota, but the bucket is only filled to the quota rate for a specified time period. In one implementation, each user may have a corresponding token bucket.

A token bucket may allow for a burst rate of usage for a short time that is higher than the quota rate. For example, with a quota of 50 requests per 10 seconds, the system may allow 20 requests in a one second interval, provided that there are 20 tokens available due to a recent usage less than the quota rate.

In one embodiment, the actions of block 514 may be implemented by use of token bucket techniques. A token bucket for evaluating system quotas may be implemented by a different token bucket structure than for those used to evaluate individual user quotas.

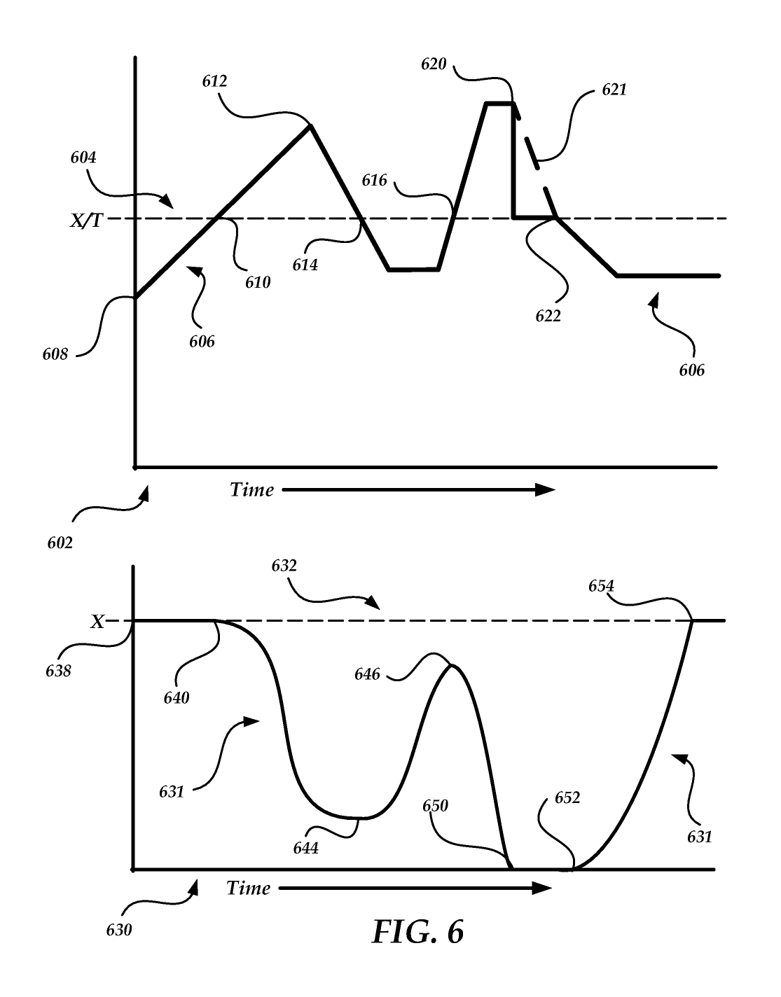

FIG. 6 contains two graphs that illustrate the use of a token bucket to manage user requests. In the graphs, it is assumed that there is a quota R, where R may be expressed as X requests per T second time interval. Throughput graph 602 shows the throughput of user requests as a function of time. Token graph 630 shows the availability of tokens from the token bucket as a function of time. Function line 631 shows the number of available tokens. The time scales of both graphs are the same, so that the throughput and corresponding token availability for each time instance may be viewed.

In graph 602, dashed line 604 represents the quota rate of R=X/T, with a bucket size of X. Function line 606 shows the rate of requests received. Point 608 is the rate of requests at time zero. In graph 630, dashed line 632 represents the maximum number of tokens that may be available, which is X in this example. Point 638 shows the number of tokens available at time zero. This value is X.

In this example, as time increases from zero, the request rate increases. At point 610, the request rate is equal to the quota rate. Below this rate, tokens are added to the bucket more quickly than they are being removed. At corresponding point 640, X tokens remain in the token bucket.

After point 610, the request rate is above the quota rate, X/T. Since there are enough tokens available, these requests are allowed. The request rate remains above the quota past a local maximum at point 612, until it crosses the dashed line 604 at point 614. The rate of requests between points 610 and 614 indicates a burst rate above the quota that is allowed by the system. In the corresponding token graph 630, the corresponding points 640 and 644 show an interval in which the tokens decrease, but remain above zero. After points 614 and corresponding point 644, the token bucket is replenished, as the request rate is below the quota.

After point 616, and corresponding point 646, the request rate again exceeds the quota. Once again, this burst rate is allowed. The available tokens decrease rapidly, until corresponding points 650 and 620. At this instant, there are zero tokens remaining. Therefore, requests are rejected and the burst rate is not maintained. The throughput is throttled to a rate not greater than the quota rate. Dashed line 621 is an example of a request rate that may be desired by the user were it not throttled by the quota system.

At point 622, and corresponding point 652, the request rate falls below the quota, allowing the number of tokens in the bucket to increase to the maximum at point 654. The remaining requests on the graph are allowed, while the number of available tokens remains at a maximum.

As illustrated, the use of a token bucket allows for bursts that exceed the quota for short time periods, while enforcing the quota over longer time periods. However, some bursts result in rejection of requests, thereby throttling the throughput.

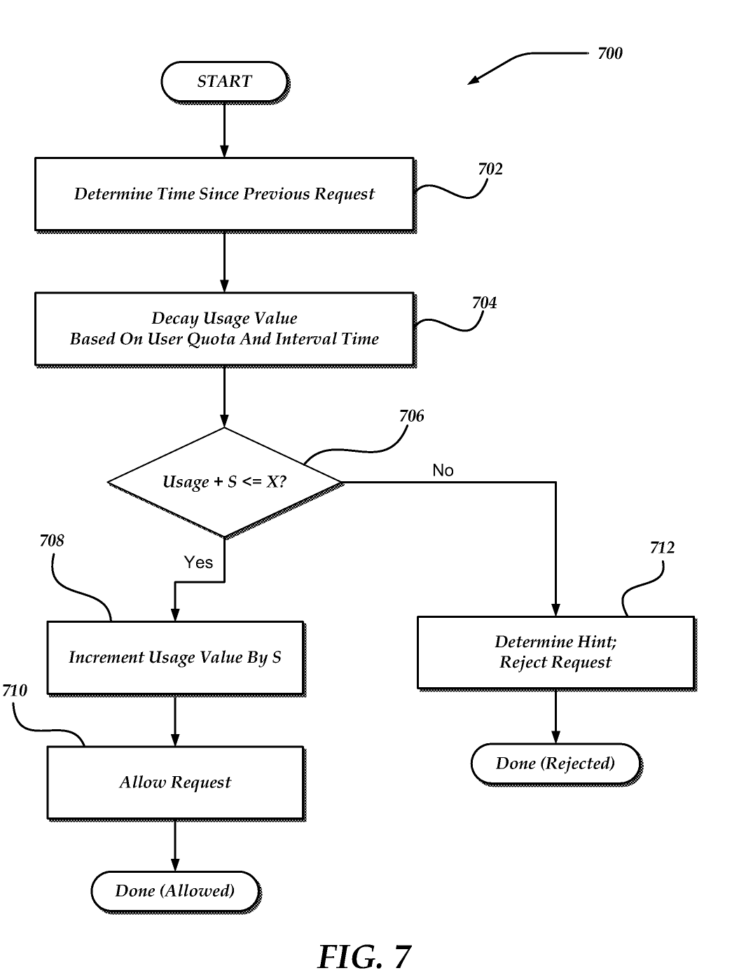

FIG. 7 illustrates a process 700 of evaluating compliance with a user quota, in accordance with one embodiment. Process 700 includes a process of determining current user quota usage data. Process 700 may be a more detailed view of the actions of block 508 of FIG. 5, and may be understood in that context. In one implementation, the actions of process 700, or at least a portion thereof, may be performed by quota component 212 of FIG. 2. In the discussion of FIG. 7, it is assumed that there is a user quota R, where R may be expressed as X requests per T second time interval, though the process may be employed with a quota on other system resources. In the discussion of FIG. 7, the terms usage and usage value refer to user quota usage values.

As discussed with respect to FIGS. 3-5, in one embodiment, prior to performance of process 700, a user request may be received and the corresponding user data may be retrieved or initialized. The user data may include the user quota usage values as previously calculated. It may also include a timestamp designating a time of a previous request or a time of a previous calculation of the user quota usage value. In one embodiment, a user's usage value is initialized to zero if it has not previously been determined, or if previous data has expired.

As illustrated, after a start block, at block 702, the amount of time since the previous request or calculation of the user quota usage value is determined. This is referred to herein as the “interval time.” This may be calculated by subtracting a current timestamp from the timestamp corresponding to the previous request or calculation. Processing may flow to block 704, where the usage data may be decayed. In one embodiment, the usage data may be decayed based on the interval time and the quota. In one implementation, the decay amount may be a product of the interval time (I) and the quota rate (R), such that the decay amount reflects a number of tokens that may be added to the token bucket during the interval time. Thus, the decay amount may be equal to (I X R). The decay amount is subtracted from the usage to determine the new usage. If the new usage is negative, it is set to zero.

As may be understood, the usage is maintained relative to the user quota rate. If requests are received and allowed at the same rate as the user quota rate, the usage remains constant. If requests are received at a greater rate than the user quota rate, the usage increases. The mechanisms of a token bucket are enforced by having a maximum allowable usage value equal to the size of the token bucket. Thus, the size of the token bucket limits the amount of usage, and therefore the amount of usage in a burst.

Process 700 may flow to decision block 706, where a determination is made of whether the request is allowable, based on a projected usage value and the token bucket size. In one implementation, the token bucket size (B) is equal to the value X, representing the number of resource units allowed for a specified time interval. The value X is used as the token bucket size in FIG. 7. However, in some implementations, the token bucket size (B) may be configured to be a number other than the number of resource units allowed for a specified time interval. For example, B may be greater than X to allow for a burst that is greater than the quota rate.

In one implementation, the projected usage value is the present usage value incremented by a requested number of resource units (S), where S represents a number of resource units corresponding to the request. For example, in one configuration, different types of requests may have different numbers of resource units associated with them, such that the value S may vary based on the type of request. In one implementation, S equals one for each request. Thus, S may be a fixed or variable value. In the illustrated process 700, the decision block determines whether the usage value (U) incremented by S is less than or equal to X. If it is, the process may flow to block 708, where the usage value is incremented by S. The process may flow to block 710, where the request is allowed and a success status is returned to a calling program.

If, at decision block 706, the usage value is greater than the value X, the process may flow to block 712. At block 712, the request may be rejected and a failure status returned to a calling program. Also at block 712, a user hint may be determined, to be returned with the failure status. As discussed above, a user hint may provide a user with information suggestive of how to send a subsequent request to increase a likelihood of success. In one embodiment, a hint may include an indication of a time period to wait prior to sending a subsequent message, allowing the usage to decay to an allowable value. More specifically, the hint may indicate an amount of time until the decay actions of block 704 reduce the usage value so that the decision block may determine that the usage value incremented by S is less than or equal to the token bucket size. In one implementation, determination of a hint may include determining a wait time W=(U+S−X)/R, which is the time it will take until (U+S<=X).

In some implementations, a hint may include information indicative of a change to the request to make a request allowable. For example, in a configuration in which requests may be associated with different amounts of a resource (as represented by the value S), a hint may indicate that a request associated with a lower amount of resource may be allowable, even though the current request is not.

Though not illustrated in FIG. 7, in one embodiment, a hint may be determined and returned in response to allowable requests, as part of block 710. A “success” hint may indicate similar information as for a “failure” hint. Though the current request is allowed, a success hint may indicate an amount of time to wait before sending a subsequent request, in order to have the subsequent request allowed. As for failure hints, a success hint may be calculated as W=(U+S−X)/R, though a negative value may be set to zero, indicating that a subsequent request may be sent immediately. In one implementation, a success hint may indicate an allowable burst size equal to a number of requests that may be immediately allowable.

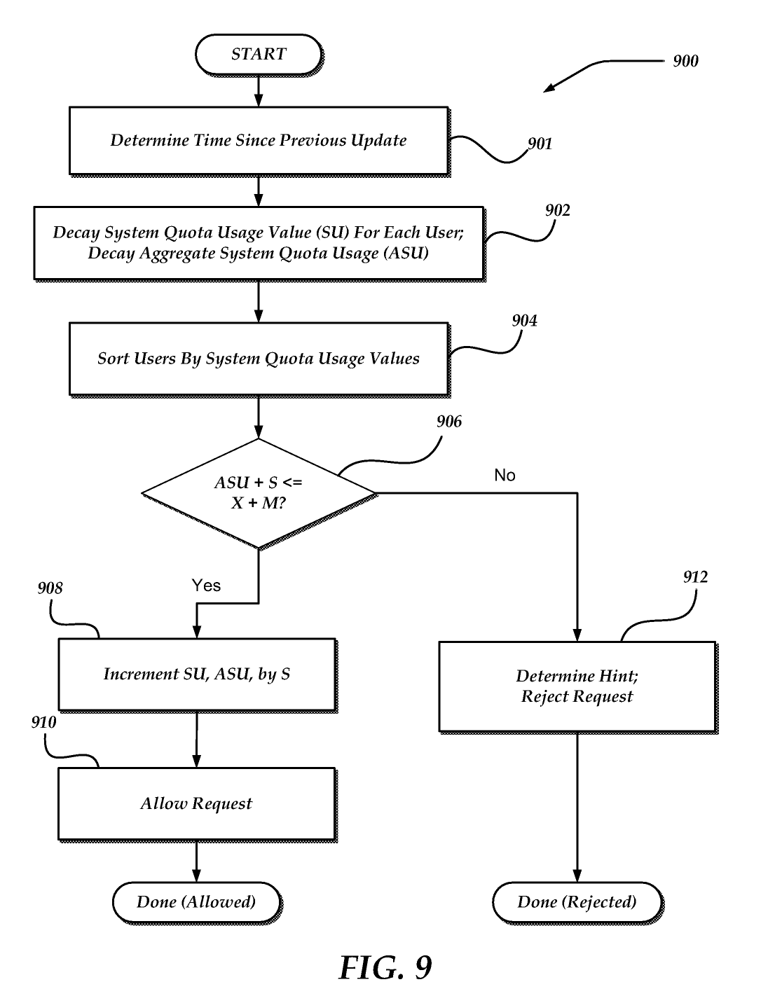

As discussed herein, in some configurations, multiple user quotas may be employed, the quotas relating to the same or different resource, with a user having a usage value corresponding to each user quota. In one implementation, the actions of blocks 704 and 706 may be performed once for each user quota. For example, the decaying action of block 704 may be performed on each usage value, followed by performing the decision block 706 for each quota and corresponding usage value. If all of the user quota usage values pass the test of decision block 706 the process may flow to block 708. If any of the user quota usage values fail the test of decision block 706, the process may flow to block 712. As discussed above, a hint corresponding to the failed quota may be determined and returned to the user. In one implementation, if a quota is exceeded, hints are determined for all quotas that are exceeded, and the most restrictive hint (e.g. the hint designating the longest wait time) is returned. In one implementation, a system quota hint, as discussed with respect to FIG. 9, may be determined in addition to a user quota hint, and the most restrictive hint returned.

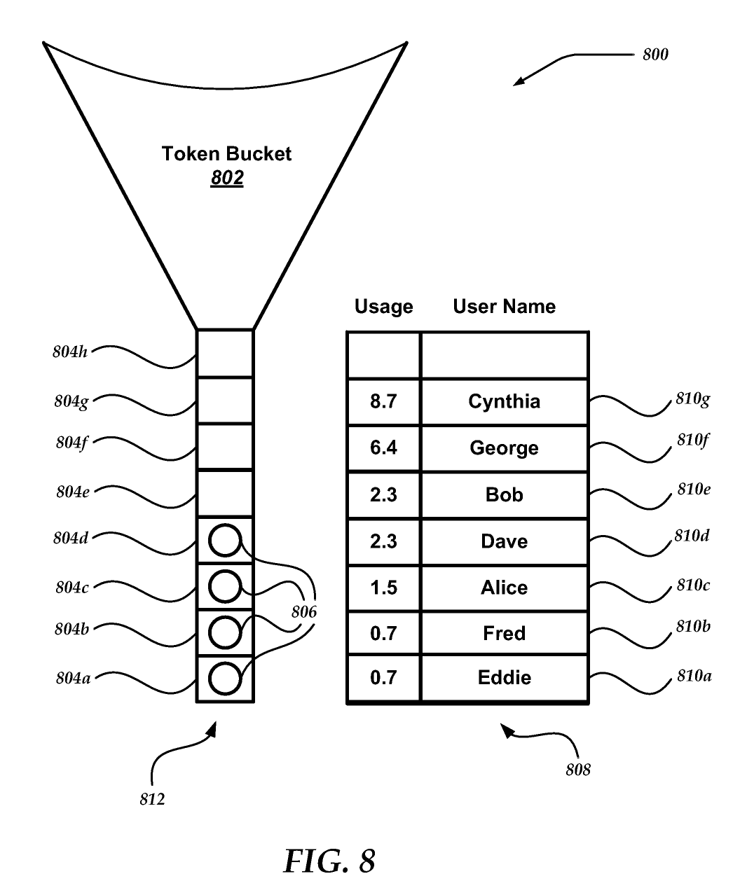

FIG. 8 is a conceptual view of a system 800 for evaluating compliance with a system quota, in accordance with one embodiment. The actions of block 514 of FIG. 5 may result in a system such as system 800, and may be understood in that context. In one implementation, the actions related to system 800, or at least a portion thereof, may be performed by quota component 212 of FIG. 2. As illustrated, FIG. 8 shows an example of a particular configuration of system 800.

As illustrated in FIG. 8, token bucket 802 represents a mechanism for enforcing a system quota on multiple users. System 800 includes a reservation list 812. Reservation list 812 may be considered to be “gravity fed” by token bucket 802, such that available tokens fall to the next available slot 804 of the reservation list 812. Surplus tokens remain within token bucket 802 until needed. As illustrated, reservation list 812 includes slots 804a-h. Each of slots 804a-d contains a corresponding token 806, while slots 804e-h are currently empty.

System 800 further includes user table 808, containing an entry 810a-g corresponding to each user. Each entry 810a-g includes fields for a user name and a corresponding system quota usage value. In one implementation, the entries 810a-g are sorted by the system quota usage value field, such that the bottom entry 810a represents the user (“Eddie”) with the lowest system quota usage value (0.7) and the top entry 810g represents the user (“Cynthia”) with the highest system quota usage value (8.7). The illustrated example is a snapshot of an example system. The usage values are dynamic and may be continuously recalculated. At each calculation, the entries 810a-g may be resorted based on the most recent system quota usage data.

In one implementation, a user's system quota usage value may be recalculated each time the system receives a request from the user. System quota usage values of other users are not necessarily recalculated at that time. Therefore, the system quota usage values corresponding to some or all users other than the current user may be stale. A stale value may be higher than it would be if it were continuously recalculated. In one implementation, the system quota usage values corresponding to one or more other users may be recalculated when the current user's value is recalculated.

Beginning with the bottom entry, a certain number of users may have a conceptual “reservation” of a token. In one implementation, the number of available reservations is equal to the number of slots 804 that contain a token 806. Thus, in the illustrated example, four slots 804a-d have a token 806, and the four users in the bottom four user entries 810a-d are considered to hold the corresponding reservation. If a request is received from any of these users, the corresponding token is given to the user, and the request is allowed. If a request is received from another user, specifically users corresponding to entries 810e-g, the request is denied. The reservation system implements a mechanism in which the users with the lowest usage rates have the highest priority in having their requests allowed.

It is to be noted that, since the system is dynamic, reservations may change, and a user holding a reservation is not guaranteed to make use of it. For example, prior to receiving a request from user “Dave” in entry 810d, a new user with a low system quota usage value may be added to user table 808, moving Dave to the fifth slot and denying him a token until a new token is added. It is also possible that the receipt of a new request from a user may increase the user's usage above the reservation level, causing the request to be rejected. In another example, prior to receiving a request from user “Bob” in entry 810e a new token may be added to the token bucket, falling into reservation slot 804e, providing Bob with a reservation and causing the next request from Bob to be allowed.

FIG. 9 illustrates a process 900 of evaluating compliance with a system quota, in accordance with one embodiment. Process 900 may be a more detailed view of the actions of block 514 of FIG. 5, and may be understood in that context. In one implementation, the actions of process 900, or at least a portion thereof, may be performed by quota component 212 of FIG. 2. In the discussion of FIG. 9, it is assumed that there is a system quota R, where R may be expressed as X requests per T second time interval. A system quota is a quota that applies to the aggregate of users. It is to be noted that R, X, and T as used to reference a system quota are not necessarily the same values as R, X, and T as used to reference an individual quota. In the discussion of FIG. 9, R, X, and T refer to a system quota.

As discussed with respect to FIGS. 3-5, in one embodiment, prior to performance of process 900, a user request may be received and the corresponding user data may be retrieved or initialized. Additionally, system quota usage values may be retrieved from a data structure such as user table 808 of FIG. 8. User table 808 may include a system quota usage value (SU) for each user, as well as an aggregate system quota usage value (ASU). It may also include a timestamp designating a time of a previous table update, or it may include timestamps corresponding to each entry, designating a time of a previous update to the entry. In one embodiment, a user's system quota usage value is initialized to zero if it has not previously been determined, or if previous data has expired.

As illustrated, after a start block, at block 901, the time since the previous table update, referred to herein as the system interval time, is determined. This may be calculated by subtracting a current timestamp from the timestamp corresponding to the previous table update.

Also at block 901, the time since the previous update of the current user's system quota usage value, referred to herein as the user's system interval time, is determined. This may be calculated by subtracting a current timestamp from the timestamp corresponding to the current user's previous system quota usage value calcuation.

Processing may flow to block 902, where the SU for the current user is decayed, based on the system quota rate and the current user's system interval time. In one embodiment, the SU decay amount may be a product of the current user's system interval time (USI) and the system quota rate (SQ), divided by the number of users (N), or (USI×SQ)/N. The SU may be decremented by this decay amount. The actions of block 902 may also include decaying the ASU by an aggregate decay rate equal to the product of the system interval time and the system quota rate, or (SI×SQ).

Process 900 may flow to block 904, where entries in a table corresponding to users may be sorted based on the system quota usage values. As illustrated in FIG. 8, in one implementation, entries 810 in user table 808 may be sorted such that the user with the highest system quota usage value is at the top of the table, with other entries ordered in descending order by system quota usage values. In one implementation, sorting the entries may be optimized by adjusting the current user's entry based on its system quota usage value and adjusting other entries based on this adjustment. Thus, if the current user's ranking does not change, other entries do not need to be changed. The term “sorting” includes optimizations such as this. As discussed above, one or more system quota usage values may be stale when sorting the user table 808.

Process 900 may flow to decision block 906, where it is determined whether sufficient resources are available for the current user. In one implementation, sufficient resources are available if ASU+S<=X+M, where S represents the number of resource units corresponding to the request, X is the number of system resources allowed per unit time, and M is the user's rank in the user table, such that the user with the highest SU has a rank of zero. Based on this, a user with a relatively low SU may be allowed a request even if a user with a higher SU is not allowed a similar request. More specifically, if the system quota usage is such that N requests are allowable, a request by any one of the N users with the lowest SU will be allowed. As discussed with respect to FIG. 8, user table 808 is dynamic. Rankings may change or number of available tokens may change. Thus, though “Dave” in table 808 may be eligible for an allowed request, a request by “Eddie” may reduce the available tokens and cause Dave's next request to be rejected.

If it is determined that the request is compliant with the system quota, the process may flow to block 908, where the SU for the requesting user and the ASU are each incremented by S, to reflect an additional resource usage. The process may flow to block 910, where the request is allowed and a success status is returned to a calling program. If, at decision block 906, a token is not available for the current user, and the request is not compliant with the system quota, the process may flow to block 912, where the request is rejected and a failure status is returned to a calling program. Also at block 912, a user hint may be determined, to be returned with the failure status. As discussed herein, a user hint may include an indication of a time period to wait prior to sending a subsequent message, or another type of suggestive information of how to send a subsequent request. In one implementation, determination of a hint may include determining a wait time W=(ASU+S×M)/R, which is the time it will take until (ASU+S<=X+M). Due to the interdependency of users with respect to system resources, a hint based on a system quota may be less reliable than a hint based on a user quota. Requests by other users may cause a system quota hint to be outdated prior to the user's next message.

Though FIGS. 8 and 9, and the associated discussion, describe a process in which users are sorted by system quota usage values, and all users are considered in the same manner, variations of these mechanisms may include one or more additional factors when considering a fair distribution of tokens. Users may be classified into two or more classifications. In one implementation, the system quota usage values of a first class may be reduced so that they have priority when being sorted. For example, system quota usage values of an administrator class may be decayed at a faster rate than regular users, to allow them more tokens at a higher system quota usage value than regular users. In one implementation, each user has a corresponding priority Pᵢ, where Pᵢ is a number greater than or equal to one, such that a higher number indicates a higher priority; the decay rate for each user may be (SI×SR×Pᵢ)/N. In other implementations, various calculations may be performed to enable higher priority users to have more requests allowed.

One aspect of the mechanisms described is that the user quota or system quota specifications may be changed dynamically without having to reset the user usage rate or locking out the user for a period of time. The quotas may be changed manually by an administrator or dynamically by a process, or by other means. For example, a quota change may be triggered based on a time of day, a date, a user's actions, or a change of user classification, as well as other factors. Changing a quota may include changing the values of R, X, or T, or a combination thereof. An additional user quota or system quota may also be added to existing quotas. In one implementation, if, when changing a quota, the user's usage value is greater than the new value of X it may be reset to X. In one implementation, if the user's usage value becomes greater than a new value of X, the user's usage value may be left unchanged, and requests are rejected until the decay rate brings the usage down to an allowable value.

It will be understood that each block of the flowchart illustrations of FIGS. 3, 4, 5, 7, and 9 and combinations of blocks in the flowchart illustrations, can be implemented by computer program instructions. These program instructions may be provided to a parallel processor to produce a machine, such that the instructions, which execute on the processor, create means for implementing the actions specified in the flowchart block or blocks. The computer program instructions may be executed by a parallel processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-implemented method for managing requests for services from a plurality of users, comprising:
a) receiving a request for a service from a user of the plurality of users;
b) determining whether the request is compliant with a system quota, based on aggregate system quota usage data and a ranking of a system quota usage datum corresponding to the user and a system quota usage datum corresponding to each user of other users of the plurality of users; and
c) selectively enabling the service based on whether the request is compliant with the system quota.

2. The method of claim 1, further comprising: determining whether the request is compliant with a user quota corresponding to the user, based on a user quota usage value corresponding to the user; and selectively enabling the service is based on whether the request is compliant with the user quota.

3. The method of claim 2, further comprising decaying the user quota usage value by an amount based on the user quota.

4. The method of claim 1, further comprising:
a) receiving a specification to modify the system quota;
b) in response to receiving the specification to modify the system quota, modifying the system quota;
c) after receiving the specification to modify the system quota, employing a system quota usage value corresponding to each of the plurality of users to determine whether other user requests corresponding are compliant with the modified system quota, without resetting the system quota usage values.

5. The method of claim 1, further comprising: determining a hint based on a time interval since a previous request by the user, the hint indicative of a timer period for the user to wait prior to sending a subsequent message; and sending the hint to the user.

6. The method of claim 1, further comprising decaying the system quota usage datum corresponding to the user based on a number of users of the plurality of users.

7. The method of claim 1, further comprising determining a hintbased on the system quota and another system quota usage value corresponding to another user of the plurality of users and sending the hint to the user.

8. The method of claim 1, the system quota indicative of a number of requests per unit of time.

9. A computer system for managing requests for services from a plurality of users, comprising:
a) a component for authenticating or authorizing each user of the plurality of users;
b) a quota component configured to perform actions including:
i) receiving a request for a service from a user of the plurality of users;
ii) determining whether the request is compliant with a user quota corresponding to the user, based on a user quota usage datum corresponding to the user;
iii) determining whether the request is compliant with a system quota, based on aggregate system quota usage data and a ranking of a system quota usage datum corresponding to the user and a system quota usage datum corresponding to each user of other users of the plurality of users;
iv) selectively, based on whether the request is compliant with the user quota or the system quota, determining a hint indicative of a time period for the user to wait prior to sending a subsequent request and sending the hint to the user;
v) if the request is compliant with the user quota and the system quota, enabling the requested service.

10. The computer system of claim 9, wherein determining the hint comprises determining a time period based on at least one of the user quota or the system quota.

11. The computer system of claim 9, the quota component actions further comprising:
if the request is compliant with a first quota of the user quota or the system quota, and the request is not compliant with a second quota of the first quota or the system quota, reverting a quota usage datum corresponding to the first quota.

12. The computer system of claim 9, wherein determining the hint comprises determining a user quota hint and a system quota hint and selecting a more restrictive hint of the user quota hint and the system quota hint.

13. The system of claim 9, wherein determining whether the request is compliant with the system quota comprises decaying the system quota usage datum corresponding to the user based on a number of users of the plurality of users and the system quota.

14. The computer system of claim 9, the quota component actions further comprising determining whether the request is compliant with at least one concurrency limit and disallowing the request if the request is not compliant with the at least one concurrency limit.

15. A computer-based system for managing requests for services from a plurality of users, comprising:
a) a mechanism for receiving a request for a service from a user of the plurality of users;
b) system quota compliance means for determining whether the request for the service is compliant with a system quota based on an ordering of the plurality of users, the ordering based on prior requests received from each of the plurality of users and a system quota usage datum corresponding to each of the plurality of users; and
c) a throttling mechanism that enables the requested service to be performed if the request complies with the system quota, and disallows the requested service if the request is not compliant with the system quota.

16. The system of claim 15 further comprising hint determination means for determining a hint indicative of a time when a subsequent request will comply with the system quota.

17. The system of claim 16, wherein the hint determination means determines an expected time when another request will be compliant with the system quota based on a ranking of each of the users of the plurality of users, the ranking based on a rate of requests received from each of the users.

18. The system of claim 15, wherein the system quota compliance means decays a system quota usage value by an amount based on a number of users of the plurality of users.

19. The system of claim 15, wherein the system quota compliance means decays a system quota usage value based on a priority of the user and a number of users of the plurality of users.

20. The system of claim 15, further comprising a user quota compliance means for determining whether the request for a service is compliant with a user quota; and the throttling mechanism disallows the requested service if the request is not compliant with the user quota.
